(19) United States
(12) Patent Application Publication
(10) Pub. No.: US 2014/0325027 A1
(43) Pub. Date: Oct. 30, 2014

(54) METHOD AND TERMINAL DEVICE FOR REQUESTING AND PRESENTING DATA

(71) Applicant: XIAOMI INC., BEIJING (CN)

(72) Inventors: Shuang Liu, Beijing (CN); Chuangqi Li, Beijing (CN); Liang Chen, Beijing (CN)

(73) Assignee: XIAOMI INC., BEIJING (CN)

(21) Appl. No.: 14/155,386

(22) Filed: Jan. 15, 2014

Related U.S. Application Data
(63) Continuation-in-part of application No. PCT/CN2013/086026, filed on Oct. 28, 2013.

(30) Foreign Application Priority Data
Apr. 24, 2013 (CN) 201310146115.7

(51) Int. Cl. H04L 29/08

(52) U.S. Cl. CPC H04L 67/02
USPC 709/219

(57) ABSTRACT

Embodiments of the present disclosure disclose a method for requesting and displaying data and terminal devices thereof. The method for requesting data in a mobile terminal comprises receiving the data comprising a data ID from a server, wherein the data is obtained according to a search request by the server, extracting the data ID from the data, and sending the data ID to a display terminal. The method for displaying data in a display terminal comprises receiving a data ID from a mobile terminal, wherein the data ID is extracted by the mobile terminal from data obtained according to a search request; acquiring data address information corresponding to the data ID from a server; and acquiring data content from the server for display according to the data address information. The present embodiments increase parallel processing ability of the mobile terminal and the display terminal.

### CROSS REFERENCE TO RELATED APPLICATION

The present application is a Continuation-In-Part of International Application No. PCT/CN2013/086026, filed Oct. 28, 2013, which is based upon and claims priority to Chinese Patent Application No. 201310146115.7, filed on Apr. 24, 2013, the entire contents of which are incorporated herein by reference.

### TECHNICAL FIELD

The present disclosure generally relates to communication and Internet technology, and more particularly, to a method, terminal device and system for requesting and displaying data.

### BACKGROUND

Currently, the interactive communication between a mobile phone and a television has become gradually developed. The mobile phone will become a center of home media controls in the future. The technology of operating the televisions and Internet set-top box using the mobile phone has become increasingly popular, wherein the mobile phone is able to transmit Internet signal instructions and control the transmission and share of data.

Conventionally, a mobile phone receives and displays the Internet data after the Internet data is searched by the mobile phone. If a data communication between the mobile phone and an Internet set-top box or a television is implemented, the mobile phone needs to download and send data to the Internet set-top box or the television, which may increase flow consumption and cost of search and display.

### SUMMARY

According to a first aspect of the present disclosure, there is provided a method for requesting data in a mobile terminal, comprising: receiving the data comprising a data ID from a server, wherein the data is obtained according to a search request by the server; extracting the data ID from the data; and sending the data ID to a display terminal.

According to a second aspect of the present disclosure, there is provided a method for presenting data in a display terminal, comprising: receiving a data ID from a mobile terminal, wherein the data ID is extracted by the mobile terminal from data obtained according to a search request; acquiring data address information corresponding to the data ID from a server; and acquiring data content from the server for display according to the data address information.

According to a third aspect of the present disclosure, there is provided a mobile terminal, comprising: a processor; and a memory for storing instructions executable by the processor; wherein the processor is configured to execute steps comprising: receiving the data comprising a data ID from a server, wherein the data is obtained according to a search request by the server; extracting the data ID from the data; and sending the data ID to a display terminal.

According to a fourth aspect of the present disclosure, there is provided a display terminal, comprising: a processor; and a memory for storing instructions executable by the processor; wherein the processor is configured to execute steps comprising: receiving a data ID from a mobile terminal, wherein the data ID is extracted by the mobile terminal from data obtained according to a search request; acquiring data address information corresponding to the data ID from a server; and acquiring data content from the server for display according to the data address information.

According to a fifth aspect of the present disclosure, there is provided a non-transitory computer-readable medium, which stores instructions for causing a processor to: receive the data comprising a data ID from a server, wherein the data is obtained according to a search request by the server; extract the data ID from the data; and sent the data ID to a display terminal.

According to a sixth aspect of the present disclosure, there is provided a non-transitory computer-readable medium, which stores instructions for commanding a processor to: receive a data ID from the mobile terminal, wherein the data ID is extracted by the mobile terminal from data obtained according to a search request; acquire data address information corresponding to the data ID from the server; and acquire data content from the server for display according to the data address information.

According to a seventh aspect of the present disclosure, there is provided a system for requesting and presenting data, which comprises a mobile terminal, a display terminal and a server, wherein the mobile terminal comprises: a processor; and a memory for storing instructions executable by the processor; wherein the processor is configured to execute steps comprising: receiving the data comprising a data ID from a server, wherein the data is obtained according to a search request by the server; extracting the data ID from the data; and sending the data ID to a display terminal, wherein the display terminal comprises: a processor; and a memory for storing instructions executable by the processor; wherein the processor is configured to execute steps comprising: receiving a data ID from the mobile terminal, wherein the data ID is extracted by the mobile terminal from data obtained according to a search request; acquiring data address information corresponding to the data ID from the server; and acquiring data content from the server for display according to the data address information.

As compared with the prior art, the embodiments of the present disclosure include the following advantages.

The embodiments of the present disclosure disclose a method for requesting and displaying data and a system thereof, wherein a mobile terminal makes a search request to a server and acquires data returned from the server. The acquired data includes a data identity (ID) but does not include data content, therefore the size of the data is less than the data containing data content. Thus, the mobile terminal may quickly make a response after acquiring the data, and the flow required for acquiring the data by the mobile terminal is much less than that of acquiring the data content, which may save the flow consumption.

Moreover, since it is not required to download data content by the mobile terminal, the electric energy consumption of a battery in the mobile terminal due to downloading the data content may be avoided. Moreover, a storage space for storing the data content may also be saved. And, it is not required to run the application program for downloading the data content for a long period of time, therefore the utilization of a central processing unit may be reduced.

Compared with the manner of sending data content to a display terminal from the mobile terminal, the manner of sending a data ID in the data from the mobile terminal to the display terminal saves flow consumption.

A search request is performed on the mobile terminal, while data is presented on the display terminal. In such manner, the separation of data request and data display may be realized, thereby increasing parallel processing ability of the mobile terminal and the display terminal.

The display terminal acquires corresponding address information according to a data ID and performs data display. Thus, the display terminal directly acquires data content from the server, thereby making full use of processing resources and storage resources in the display terminal.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is an illustrative flowchart showing a method for requesting data according to an embodiment of the present disclosure.

FIG. 2 is an illustrative flowchart showing a method for requesting data according to an embodiment of the present disclosure.

FIG. 3 is an illustrative flowchart showing a method for displaying data according to an embodiment of the present disclosure.

FIG. 4 is an illustrative flowchart showing a method for displaying data according to an embodiment of the present disclosure.

FIG. 5 is an illustrative block diagram showing an apparatus for requesting data according to an embodiment of the present disclosure.

FIG. 6 is an illustrative block diagram showing an apparatus for requesting data according to an embodiment of the present disclosure.

FIG. 7 is an illustrative block diagram showing an apparatus for displaying data according to an embodiment of the present disclosure.

FIG. 8 is an illustrative block diagram showing an apparatus for displaying data according to an embodiment of the present disclosure.

FIG. 9 is an illustrative block diagram showing a system for requesting and displaying data according to an embodiment of the present disclosure.

FIG. 10 is a schematic diagram showing a system for requesting and displaying a film according to an embodiment of the present disclosure.

### DETAILED DESCRIPTION

In order to make the purposes, features and advantages of the present disclosure more apparent, hereinafter, the present disclosure will be further described in detail in conjunction with the accompanying drawings and the specific embodiments.

In a method for requesting and displaying data and a system thereof disclosed by the embodiments of the present disclosure, a search request may be made to a server by a mobile terminal such as a smart mobile phone, and the server returns data to the mobile terminal, the data includes a data ID, and the data is selected on the mobile terminal, the data ID in the data may be extracted, and sent to an Internet set-top box, and the Internet set-top box acquires corresponding data content from the server to display on the display terminal according to the data ID.

According to the embodiments of the present disclosure, the mobile terminal is a terminal device for implementing the methods for requesting data and may include a mobile phone, a remote controller, a tablet computer, a PDA (Personal Digital Assistant) or the like.

The mobile terminal includes one or more processors, such as a computer processor or microprocessor as known in the industry to receive various data, programs and instructions, and to process such data, programs and instructions accordingly. The mobile terminal device may also include a memory which is coupled to the one or more processors and is configured to store the data, programs and instructions to be processed by the processors.

Furthermore, the mobile terminal may further include input modules, such as a touch screen, a keyboard, a mouse or the like to receive requests and inputs from a user. These are not described in details as they would be readily apparent to those skilled in the art.

Similarly, the display terminal is a terminal device for implementing the methods for displaying data and may include a television, a set-top box, a PC (Personal Computer) and a projector, or the like, and the server may include an internet server, a cloud server, or the like.

The display terminal also includes one or more processors, such as a computer processor or microprocessor as known in the industry to receive various data, programs and instructions, and to process such data, programs and instructions accordingly. Furthermore, the display terminal may also include a memory which is coupled to the one or more processors and is configured to store the data, programs and instructions to be processed by the processors. The display terminal may further include a display unit to show various data or information. These are not described in details as they would be readily apparent to those skilled in the art.

A detailed introduction to a method for requesting and displaying data and a system thereof disclosed by the present disclosure will be given by several examples as shown below.

A detailed introduction of a method for requesting data in the mobile terminal will be disclosed by an embodiment of the present disclosure below.

Referring to FIG. 1, a flowchart showing a method for requesting data in the mobile terminal is illustrated in the embodiment of the present disclosure. Referring to FIG. 1, the method includes the following steps.

In step 100, the mobile terminal receives data from a server.

The data may be obtained by the server according to a search request which may include a keyword.

The keyword may be inputted by the mobile terminal, such as a mobile phone, a tablet computer, a PDA, or the like. Furthermore, the keyword may be a word, a character, or the like.

The obtained data includes a data ID, wherein the data ID in each server or cloud of the server is unique. The data ID may be only a serial number of the data, the data ID may further include some parameters of the data or the like, and these parameters may be a category parameter of the data, storage address parameter of the data, or the like.

A precondition for performing step 100 may be to send a keyword search request to a server by the mobile terminal, and to obtain data by performing the search request at the server side according to the keyword.

Moreover, the data may be displayed and transmitted in a form of data list.

In step 102, the mobile terminal extracts a data ID from the data and sending the data ID to a display terminal.

The data ID is extracted from the data after the data is received from the server.

Each of data contains a unique data ID.

The extracted data ID is sent to the display terminal, so that the display terminal obtains the data ID, namely, the display terminal obtains a data ID which has a corresponding relationship with the keyword.

Accordingly, the embodiment of the present disclosure discloses a method for requesting data, which has the following advantages.

The mobile terminal makes a search request to a server and acquires data returned from the server. The acquired data includes a data identity (ID) but does not include data content, and therefore the size of the data received by the mobile terminal is less than the data containing data content. Thus, the mobile terminal may quickly make a response after acquiring the data, and the data flow required for acquiring the data by the mobile terminal is much less than that for acquiring the data content, which saves flow consumption.

Moreover, since it is not required to download data content by the mobile terminal, the electric energy consumption of a battery in the mobile terminal due to downloading the data content by an application program may be avoided, a storage space used to hold the data content in the mobile terminal may also be saved. And, it is not required to run the application program for downloading the data content for a long period of time, therefore the utilization of a central processing unit may be reduced.

Compared with the manner of sending data content to the display terminal from the mobile terminal, the manner of sending a data ID in the data from the mobile terminal to the display terminal saves flow consumption.

A detailed introduction of a method for requesting data in a mobile terminal will be disclosed by the embodiment of the present disclosure below.

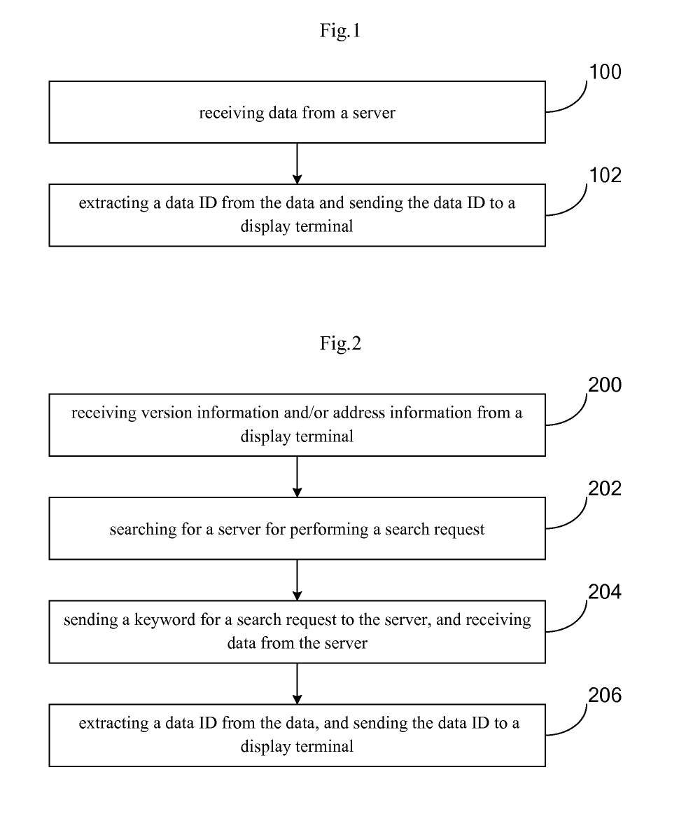

Referring to FIG. 2, a flowchart showing a method for requesting data in the mobile terminal is illustrated in the embodiment of the present disclosure.

In step 200, the mobile terminal receives version information and/or address information from a display terminal. The version information may be hardware version information of the display terminal, or may also be software version information of the display terminal.

The address information may include address information of the display terminal and address information of the server.

For example, the address information may be IP (Internet Protocol) address information, and the IP address information may include IP address information of the display terminal and IP address information of the server.

The version information may have a mapping relationship with the address information of the server, namely, after the version information of the display terminal is obtained, the address information of the server corresponding to the display terminal may be determined according to the mapping relationship.

For example, in step 200, the mobile terminal may receive the version information from the display terminal, or receive the address information from the display terminal, or receive the version information and the address information from the display terminal.

For instance, data formats of the version information and the address information may be shown as {“version”: “display terminal IP address”, “server”: “shuju.com.cn”}.

In step 202, the mobile terminal searches for a server for performing a search request. Step 202 may be divided into two situations as below.

In one case, the search for the server can be performed according to the address information of the server.

For example, the address information of the server is 123.125.21.101, and may also include a port, such as 123.125.21.101: 40003 or the like, and the server may be searched by hypertext transport protocol (http) according to the address information of the server.

In another case, the search for the server can be performed by determining the address information of the server according to the mapping relationship, and then search for the server according to the obtained address information of the server.

For example, the received version information of the display terminal is V10.0.0.9, the address information of the server corresponding to V10.0.0.9 may be determined to be 123.125.21.101 according to the mapping relationship between the version information and the address information of the server, and then the server may be searched by the http according to the address information of the server.

In step 204, the mobile terminal sends a keyword for a search request to the server, and receives data from the server.

The data may be searched by the server according to the keyword, and a search interface may be a standard http interface.

The keyword may be input by a touch, a button, or a voice command.

For example, the keyword may be input by various smart input methods in the mobile terminal such as a smart mobile phone.

The data may include a data ID, and the data may also include data prompt information and data attribute information. However, the data received by the mobile terminal does not include data content.

Herein, the data prompt information may include a data name related to the keyword or the like.

When the data is a film, the data may include the following contents as an example to illustrate a structure of the data:

public int mediaID; // film id
public int flag;
public int resolution; // marking resolution of the film
public String category; // category
public String mediaName; // title
public String director; // director
public String actors; // actors
public String tags; // types
public ImageUrlInfo smallImageURL; //small cover image
public float score =0.0f; //score
public int setNow; // current set
public int playLength; // play length
public String area; // area
public String issueDare; // issue time
public String lastIssueDate; // last issue update date
public int setCount; // total sets
public int playCount; // play times
public int scoreCount; // score times
public int mediaSetType;// single set, multiple sets

In step 206, the mobile terminal extracts a data ID from the data, and sends the data ID to the display terminal.

For example, an implementation of extracting the data ID from the data in step 206 may be accomplished by acquiring a touch item list and extracting the data ID from the data based on the touch item list. Herein, the touch item list is acquired, upon detecting a predefined touching operation on a touch screen of the mobile terminal, by invoking a program interface corresponding to the predefined touching operation.

For example, after a touch operation on a mobile terminal such as a smart mobile phone is detected, a touch item list may be obtained by an onitemselectionlistener interface, and then a data ID is extracted from the touch item list. In addition to the data ID, the touch item list may also include data attribute information of the data or the like.

Moreover, the data ID is sent to the display terminal. The data ID may be sent via airplay (a wireless technology from Apple Inc), MiLink, Bluetooth, infrared protocol in a format such as {“data ID”: “data name”} or the like.

Accordingly, the embodiment of the present disclosure discloses a method for requesting data which has the following advantages.

The mobile terminal makes a search request to a server and acquires data returned from the server. The acquired data includes a data identity (ID) but does not include data content, and therefore the size of the data received by the mobile terminal is less than the data containing data content. Thus, the mobile terminal may quickly make a response after acquiring the data, and the data flow required for acquiring the data by the mobile terminal is much less than that for acquiring the data content, which saves the flow consumption.

Moreover, since it is not required to download data content by the mobile terminal, the electric energy consumption of a battery in the mobile terminal due to downloading the data content by an application program may be avoided, a storage space used to hold the data content in the mobile terminal may also be saved. And, it is not required to run the application program for downloading the data content for a long period of time, therefore the utilization of a central processing unit may be reduced.

Compared with the manner of sending data content to a display terminal from the mobile terminal, the manner of sending a data ID in the data from the mobile terminal to the display terminal saves flow consumption.

A detailed introduction of a method for displaying data in the display terminal will be disclosed by the embodiment of the present disclosure below.

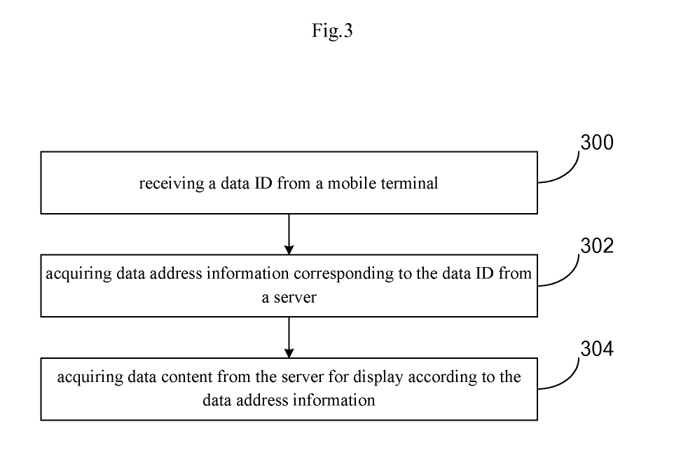

Referring to FIG. 3, a flowchart showing a method for displaying data will be illustrated in the embodiment of the present disclosure.

In step 300, the display terminal receives a data ID from a mobile terminal.

The data ID may be extracted by the mobile terminal from data obtained according to a search request. The mobile terminal performs a keyword search request to obtain data includes a data ID from a server.

In step 302, the display terminal acquires data address information corresponding to the data ID from a server.

From the server, the data ID has a corresponding relationship with the data address information, and one data ID may correspond to a plurality of data address information.

In step 304, the display terminal further acquires data content from the server for display according to the data address information.

Accordingly, the embodiment of the present disclosure discloses a method for displaying data, which has the following advantages.

Compared with the manner of receiving data content (data content) from a mobile terminal, the manner of receiving a data ID from the mobile terminal saves flow consumption.

The acquiring of corresponding address information according to a data ID and displaying data locally is achieved by directly acquiring data content from a server by the display terminal, which may make full use of processing resources and storage resources of the display terminal.

A detailed introduction to a method for displaying data in the display terminal will be disclosed by the embodiment of the present disclosure below.

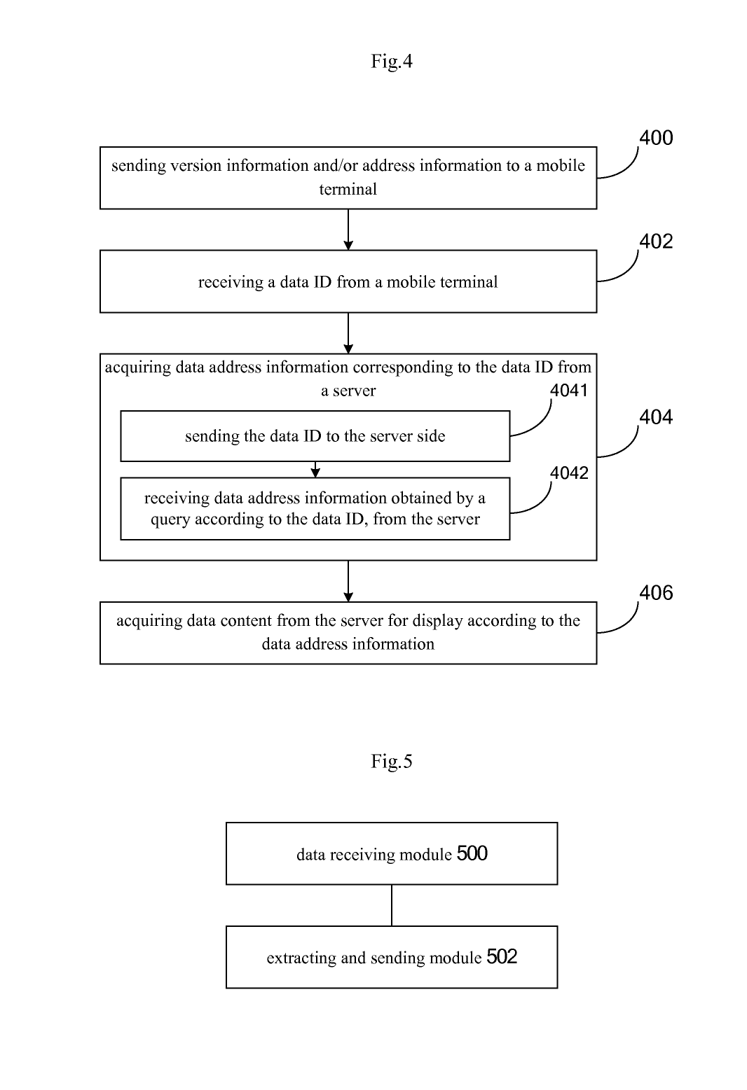

Referring to FIG. 4, a flowchart showing a method for displaying data in the display terminal is illustrated according to an embodiment of the present disclosure.

In step 400, the display terminal sends version information and/or address information to a mobile terminal.

The version information may be hardware local version information, or may also be software local version information.

The address information may include local address information and address information of a server. Herein the local address information represents the address information of the display terminal.

For example, the address information may be IP address information, and the IP address information may include IP local address information and IP address information of the server.

The version information may have a mapping relationship with the address information of the server, namely, after the version information of the display terminal is obtained, the address information of the server corresponding to the version information of the display terminal may be determined according to the mapping relationship. The version information of the display terminal may be also called as “local version information”.

For example, in step 400, the display terminal may send the local version information to the mobile terminal, or send the local address information to the mobile terminal, or send the local version information and the local address information to the mobile terminal.

For instance, data formats of the version information and the address information may be shown as {“version”: “local IP address”, “server”: “shuju.com.cn”}.

In step 402, the display terminal receives a data ID from the mobile terminal.

The data ID is extracted by the mobile terminal from data obtained from the server according to a search request. The data received by the mobile terminal may be displayed and transmitted in a form of data list.

The data ID may be stored on the server.

The data may be searched by the server according to a keyword which is input through a touch, a button or a voice command in the mobile terminal.

For example, the keyword may be inputted by various smart input methods in the mobile terminal such as a smart mobile phone.

In addition to the data ID, the data may also include data prompt information and data attribute information.

Herein, the data prompt information may include a data name related to the keyword.

When the data is a film, the data may include the following contents as an example to illustrate a structure of the data:

public int mediaID; // film id
public int flag;
public int resolution; // marking resolution of the film
public String category; // category
public String mediaName; // title
public String director; // director
public String actors; // actors
public String tags; // types
public Image UrlInfo smallImageURL; //small cover image
public float score =0.0f; //score
public int setNow; // current set
public int playLength; // play length
public String area; // area
public String issueDare; // issue data
public String lastIssueDate; // last issue update date
public int setCount; // total sets
public int playCount; // play times
public int scoreCount; // score times
public int mediaSetType;// single set, multiple sets

In step 404, the display terminal acquires data address information corresponding to the data ID from the server.

For example, step 404 may include Sub-step 4041, which requires sending the data ID to the server, and Sub-step 4042, which requires receiving the data address information corresponding to the data ID from the server, wherein the data address information is obtained from searching the data ID by the server.

At the server side, the data ID corresponds to the data address information. Furthermore, one data ID may correspond to a plurality of data address information simultaneously.

In step 406, the display terminal acquires data content from the server for display according to the data address information.

For example, in step 406, the display terminal may access the data address information, and download the data content from the server for displaying locally.

For instance, the data address information may be uniform resource locator (URL) information. If the data is in the form of video, the video itself may be downloaded to the local to be played according to the URL information, or may be played in a form of streaming media.

Accordingly, the embodiment of the present disclosure discloses a method for displaying data which has the following advantages.

Compared with the manner of receiving data content (data content) from a mobile terminal, the manner of receiving a data ID from the mobile terminal saves flow consumption.

The acquiring of corresponding address information according to a data ID and displaying data locally is achieved by directly acquiring data content from a server by the display terminal, which may make full use of processing resources and storage resources of the display terminal.

A detailed introduction of an apparatus for requesting data in the mobile terminal will be disclosed by the embodiment of the present disclosure below.

Referring to FIG. 5, a block diagram showing an apparatus for requesting data in the mobile terminal is illustrated according to an embodiment of the present disclosure.

The apparatus for requesting data may include a data receiving module 500 and an extracting and sending module 502.

Hereinafter, the detailed introduction of functions of the above modules and relationships between the modules will be given respectively.

The data receiving module 500 is configured to receive data from a server.

The data may be obtained by the server according to a search request, and the data may include a data ID.

The extracting and sending module 502 is configured to extract the data ID from the data, and send the data ID to a display terminal.

Accordingly, the embodiment of the present disclosure discloses an apparatus for requesting data which has the following advantages.

The mobile terminal makes a search request to a server and acquires data returned from the server. The acquired data includes a data identity (ID) but does not include data content, and therefore the size of the data is less than the data containing data content. Thus, the mobile terminal may quickly response after acquiring the data, and the flow required for acquiring the data by the mobile terminal is much less than that for acquiring the data content, which saves the flow consumption.

Moreover, since it is not required to download data content by the mobile terminal, the electric energy consumption of a battery in the mobile terminal due to downloading the data content by an application program may be avoided, a storage space used to hold the data content in the mobile terminal may also be saved. And, it is not required to run the application program for downloading the data content for a long period of time, therefore the utilization of a central processing unit may be reduced.

Compared with the manner of sending data content to a display terminal from the mobile terminal, the manner of sending a data ID in the data from the mobile terminal to the display terminal saves flow consumption.

A detailed introduction of an apparatus for requesting data in the display terminal will be disclosed by the embodiment of the present disclosure below.

Referring to FIG. 6, a block diagram showing an apparatus for requesting data in the display terminal is illustrated in the embodiment of the present disclosure.

The apparatus for requesting data may include a version information receiving module 600, a first search module 602, an address information receiving module 604, a second search module 606, a data receiving module 608, and an extracting and sending module 610.

Hereinafter, the detailed introductions of functions of the above modules and relationships between the modules will be given respectively.

The version information receiving module 600 is configured to receive version information from the display terminal before the data receiving module 608 receives data from a server.

The version information may have a mapping relationship with address information of the server.

The first search module 602 is configured to determine the address information of the server according to the mapping relationship and search for the server according to the address information of the server.

The address information receiving module 604 is configured to receive address information from the display terminal before the data receiving module 606 receives data from a server, wherein the address information may include address information of the display terminal and address information of the server.

The second search module 606 is configured to search for the server according to the address information of the server.

The data receiving module 608 is configured to receive data from a server.

The data may be obtained by the server according to a search request, and the data may include a data ID. The search request may include a search keyword.

The data may further include data prompt information and data attribute information.

Herein, the data prompt information may include a data name.

The keyword may be inputted by a touch, a button, or a voice command.

The extracting and sending module 610 is configured to extract a data ID from the data and send the data ID to a display terminal.

For example, in extracting the data ID from the data, the extracting and sending module 610 is further configured to acquire a touch item list and extract the data ID from the data based on the touch item list.

Accordingly, the embodiment of the present disclosure discloses an apparatus for requesting data which has the following advantages.

The mobile terminal makes a search request to a server and acquires data returned from the server. The acquired data includes a data identity (ID) but does not include data content, and therefore the size of the data is less than the data containing data content. Thus, the mobile terminal may quickly response after acquiring the data, and the flow required for acquiring the data by the mobile terminal is much less than that for acquiring the data content, which saves the flow consumption.

Moreover, since it is not required to download data content by the mobile terminal, the electric energy consumption of a battery in the mobile terminal due to downloading the data content by an application program may be avoided, a storage space used to hold the data content in the mobile terminal may also be saved. And, it is not required to run the application program for downloading the data content for a long period of time, therefore the utilization of a central processing unit may be reduced.

Compared with the manner of sending data content to a display terminal from the mobile terminal, the manner of sending a data ID in the data from the mobile terminal to the display terminal saves flow consumption.

A detailed introduction of an apparatus for displaying data in the display terminal will be disclosed by the embodiment of the present disclosure below.

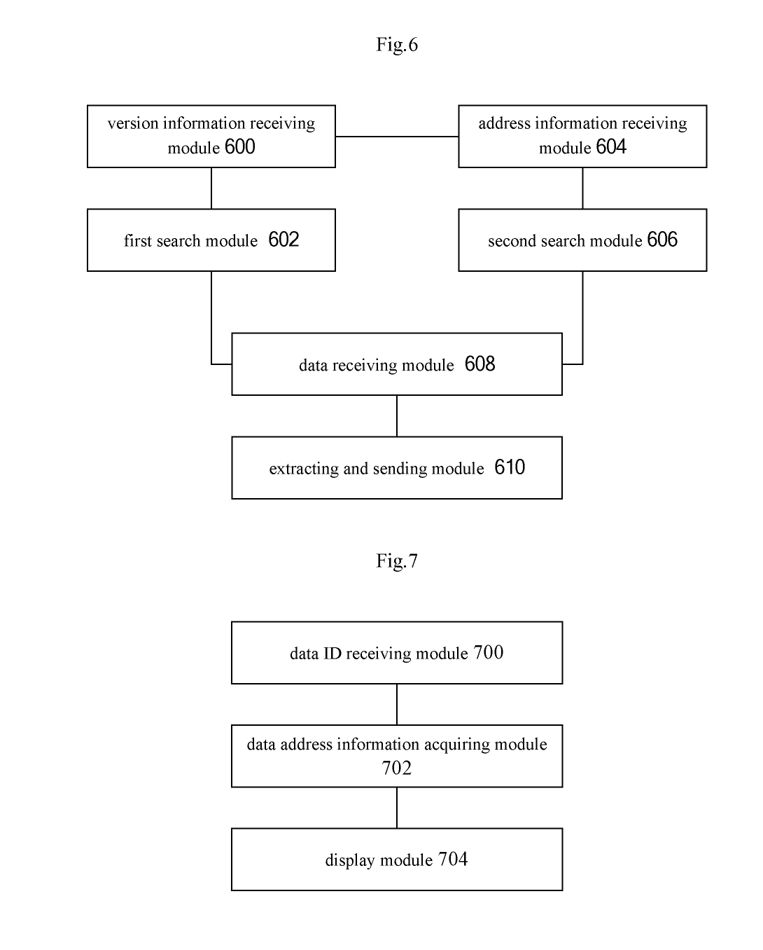

Referring to FIG. 7, a block diagram showing an apparatus for displaying data in the display terminal is illustrated according to an embodiment of the present disclosure.

The apparatus for displaying data may include a data ID receiving module 700, a data address information acquiring module 702, and a display module 704.

Hereafter, the detailed introductions of functions of the above modules and relationships between the modules will be given respectively.

The data ID receiving module 700 is configured to receive a data ID from a mobile terminal.

The data ID may be extracted by the mobile terminal from data obtained according to a search request.

The data address information acquiring module 702 is configured to acquire data address information corresponding to the data ID from a server.

The display module 704 is configured to acquire data content from the server for display according to the data address information.

Accordingly, the embodiment of the present disclosure discloses an apparatus for displaying data which has the following advantages:

Compared with the manner of receiving data content (data content) from a mobile terminal, the manner of receiving a data ID from the mobile terminal saves flow consumption.

The acquiring of corresponding address information according to a data ID and displaying data locally is achieved by directly acquiring data content from a server by the display terminal, which may make full use of processing resources and storage resources of the display terminal.

A detailed introduction of an apparatus for displaying data will be disclosed by the embodiment of the present disclosure below.

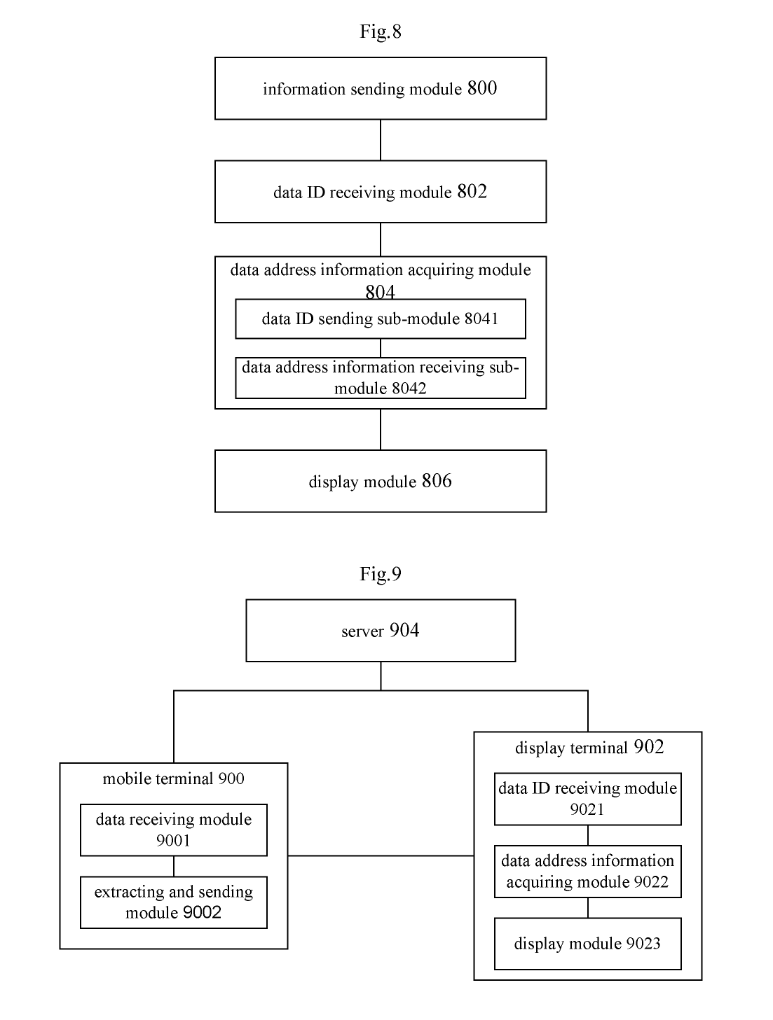

Referring to FIG. 8, a block diagram showing an apparatus for displaying data is illustrated in the embodiment of the present disclosure.

The apparatus for displaying data may include an information sending module 800, a data ID receiving module 802, a data address information acquiring module 804, and a display module 806.

Herein, the data address information acquiring module 804 may include a data ID sending sub-module 8041 and a data address information receiving sub-module 8042.

Hereinafter, the detailed introduction of functions of the modules and the sub-modules and relationships between the modules and the sub-modules will be given respectively.

The information sending module 800 is configured to send local version information and/or address information to the mobile terminal before the data ID receiving module 802 receives a data ID from the mobile terminal.

The address information may include local address information and address information of a serve.

The version information may have a mapping relationship with address information of the server.

The data ID receiving module 802 is configured to receive a data ID from a mobile terminal.

The data ID may be extracted by the mobile terminal from data obtained according to a search request.

The data ID may be stored at the server.

The data may be searched by the server according to a keyword, which is inputted through a touch, a button or a voice in the mobile terminal.

The data may further include data prompt information and data attribute information.

Herein, the data prompt information may include a data name.

The data address information acquiring module 804 is configured to acquire data address information corresponding to the data ID from a server.

For example, the data address information acquiring module 804 may include a data ID sending sub-module 8041 configured to send the data ID to the server; a data address information receiving sub-module 8042 configured to receive the data address information corresponding to the data ID from the server, wherein the data address information is obtained from searching the data ID by the server; and a display module 806 configured to acquire data content from the server side to perform for display according to the data address information.

For example, the display module 806 accesses the data address information and downloads the data content from the server for displaying locally.

Accordingly, the embodiment of the present disclosure discloses an apparatus for requesting data which has the following advantages.

Compared with the manner of receiving data content (data content) from a mobile terminal, the manner of receiving a data ID from the mobile terminal saves flow consumption.

The acquiring of corresponding address information according to a data ID and displaying data locally is achieved by directly acquiring data content from a server by the display terminal, which may make full use of processing resources and storage resources of the display terminal.

A detailed introduction of a system for requesting and displaying data will be disclosed by the embodiment of the present below.

Referring to FIG. 9, a block diagram showing a system for requesting and displaying data is illustrated in the embodiment of the present disclosure.

The system for requesting and displaying data may include a mobile terminal 900, a display terminal 902, and a server 904.

Wherein the mobile terminal 900 may include a data receiving module 9001 and an extracting and sending module 9002.

The display terminal 902 may include a data ID receiving module 9021, a data address information acquiring module 9022, and a display module 9023.

Hereinafter, a detailed introduction of functions of devices and the modules and relationships between the devices and the modules will be given respectively.

The mobile terminal 900 may include a data receiving module 9001 configured to receive data from the server, wherein, the data may be obtained by the server according to a search request, and the data may include a data ID, and an extracting and sending module 9002 configured to extract the data ID from the data, and send the data ID to the display module.

The display terminal 902 may include a data ID receiving module 9021 configured to receive the data ID from the mobile terminal; a data address information acquiring module 9022 configured to acquire data address information corresponding to the data ID from the server; and a display module 9023 configured to acquire data content from the server for display according to the data address information.

If the data is a film, for instance, the system for requesting and displaying data will be an apparatus for requesting and displaying a film.

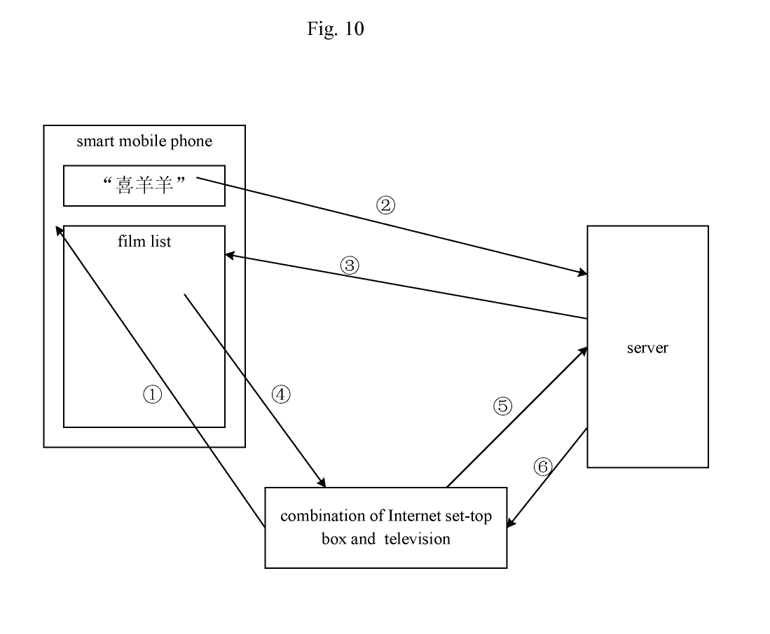

Referring to FIG. 10, a schematic diagram showing a system for requesting and displaying a film in the embodiment of the present disclosure is illustrated.

The system for requesting and presenting a film may include a mobile terminal (such as a smart mobile phone), a display terminal (such as a combination of an Internet set-top box and a television) and a server.

The information transmission among the smart mobile phone, a combination of the Internet set-top box and the television, and the server as well as the process thereof are given as follows:
1. The version information of the Internet set-top box and address information of the server is acquired.
2. A keyword “ [symbol] (Happy Sheep)” for a search request of a film is inputted to a smart mobile phone and sent to the server.
3. The server returns a search result (such as a film list, the film list including a film ID) to the smart mobile phone.
4. The film list is displayed on the smart mobile phone, and the film ID is sent to the Internet set-top box.
5. The Internet set-top box sends the film ID to the server to request for a film playing address.
6. The server returns the film playing address to the Internet set-top box, and the Internet set-top box downloads the film content and plays the film according to the playing address and displays the film on a screen of a television.

Accordingly, the embodiment of the present disclosure discloses a system for requesting and presenting data which has the following advantages.

The display terminal (such as a combination of an Internet set-top box and a television) may provide a function of searching for data by controlling a device such as a remote control (a hardware remote controller). However, with simple button type design of the remote control of the display terminal, it is very hard to input a word on a screen of a television. Even if the display terminal provides input methods such as Nine-square-grids input method, a first letter of Pinyin or stroke input method, it requires continuously operate of the remote control multiple times in order to input a letter onto the display terminal due to the button control of the remote control. However, an input method of a mobile terminal such as a smart mobile phone may allow the direct position of a finger on a button or a virtual button of the mobile terminal, and may be combined with various smart input methods on the mobile terminal, such that a keyword may be quickly and accurately be inputted into the mobile terminal.

Moreover, since the display terminal can only input a stroke or a letter but not directly input a Chinese character, and the input method of the mobile terminal may directly input a Chinese character, thus a keyword can be obtained more accurately.

If the data is directly searched by the display terminal, none of the recommended prompt information, which can be obtained through a mobile terminal, may be obtained except for the required data. However, after the data is searched by using a mobile terminal, data prompt information (for example, a prompt of current popular films) may also be displayed in a data list. For example, if a keyword “ [symbol] (Happy)” is input by a mobile terminal, some hot searches such as “ [symbol] (Happy Camp)”, “ [symbol] (Happy year of the sheep)” or the like may be recommended in the data list.

The information search results of the display terminal is limited, and if it is desired to select different information from the search results, multiple inputs via the button control of the remote control of the display terminal may be required. Moreover, the data list searched by using the mobile terminal further includes data attribute information, and the data attribute information may be selected by simple touch operations on the mobile terminal.

Given that the display terminal may be placed far away from a user, the words displayed on the display terminal may not be seen clearly, which may easily result in wrongful operations by the user. Meanwhile, the operations of searching and selecting data via the mobile terminal can be performed more accurately and conveniently.

The mobile terminal makes a search request to a server and acquires data returned from the server. The acquired data includes a data identity (ID) but does not include data content, and therefore the size of the data received by the mobile terminal is less than the data containing data content. Thus, the mobile terminal may quickly make a response after acquiring the data, and the data flow required for acquiring the data by the mobile terminal is much less than that for acquiring the data content, which saves the flow consumption.

Moreover, since it is not required to download data content by the mobile terminal, the electric energy consumption of a battery in the mobile terminal due to downloading the data content by an application program may be avoided, a storage space used to hold the data content in the mobile terminal may also be saved. And, it is not required to run the application program for downloading the data content for a long period of time, therefore the utilization of a central processing unit may be reduced.

Compared with the manner of sending data content to a display terminal from the mobile terminal, the manner of sending a data ID in the data from the mobile terminal to the display terminal saves flow consumption.

A search request is sent by the mobile terminal, and data content is displayed on the display terminal. In such manner, the separation of data request and data content display may be realized, thereby increasing parallel processing ability of the mobile terminal and the display terminal.

The display terminal acquires corresponding address information according to a data ID and performs data display. Thus, the display terminal directly acquires data content from the server, thereby making full use of processing resources and storage resources in the display terminal.

Those skilled in the art may appreciate that all or a part of steps in the above embodiments may be implemented by a hardware or may be implemented in a related hardware instructed by instructions stored in a non-transitory computer readable storage medium. The computer can also include the mobile terminal and display terminal as defined in the present disclosure.

The non-transitory computer readable storage medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory of the terminals.

Since the embodiments of the system are substantially similar to those of the method, the description thereof is relatively simple, and some portions related to the method may refer to the description of the embodiments of the method.

The respective embodiments in the present description are described in a progressive manner, and each of the embodiments describes a focus different from that of the other embodiment. Thus, the similar parts between the respective embodiments may refer to each other.

The detailed description of a method for requesting and displaying data and an apparatus thereof disclosed by the embodiments of the present disclosure is given above. Specific examples are used hereby to explain the principle and embodiments of the present disclosure and description of the above embodiments are only useful for understanding a method and its focus of the present disclosure. Meanwhile, one ordinarily skilled in the art may make any modification in the specific embodiments and application scope, according to the concept of the present disclosure. Accordingly, the contents disclosed in this description should not be construed to limit the present disclosure.

What is claimed is:

1. A method for requesting data in a mobile terminal, comprising:
receiving the data comprising a data ID from a server, wherein the data is obtained according to a search request by the server;
extracting the data ID from the data; and
sending the data ID to a display terminal.

2. The method according to claim 1, wherein the method further comprises:
receiving version information from the display terminal, wherein the version information has a mapping relationship with address information of the server;
determining the address information of the server according to the mapping relationship; and
searching for the server according to the address information of the server.

3. The method according to claim 1, wherein the method further comprises:
receiving address information from the display terminal, wherein the address information comprises address information of the display terminal and address information of the server; and
searching for the server according to the address information of the server.

4. The method according to claim 1, wherein extracting the data ID from the data comprises:
acquiring a touch item list; and
extracting the data ID from the data through the touch item list.

5. The method according to claim 1, wherein the data further comprises data prompt information and data attribute information.

6. A method for displaying data in a display terminal, comprising:
receiving a data ID from a mobile terminal, wherein the data ID is extracted by the mobile terminal from data obtained according to a search request;
acquiring data address information corresponding to the data ID from a server; and
acquiring data content from the server for display according to the data address information.

7. The method according to claim 6, wherein the method further comprises:
sending version information and/or address information to the mobile terminal,
wherein the address information includes local address information and address information of the server, and wherein the version information has a mapping relationship with the address information of the server.

8. The method according to claim 6, wherein acquiring the data address information corresponding to the data ID from the server comprises:
sending the data ID to the server; and
receiving the data address information corresponding to the data ID from the server, wherein the data address information is obtained from searching the data ID by the server.

9. The method according to claim 6, wherein acquiring the data content from the server for display according to the data address information comprises:
accessing the data address information; and
downloading the data content from the server for displaying locally.

10. The method according to claim 6, wherein the data further comprises data prompt information and data attribute information.

11. A mobile terminal, comprising:
a processor; and
a memory for storing instructions executable by the processor;
wherein the processor is configured to execute steps comprising:
receiving the data comprising a data ID from a server, wherein the data is obtained according to a search request by the server;
extracting the data ID from the data; and
sending the data ID to a display terminal.

12. The mobile terminal according to claim 11, wherein the processor is further configured to execute steps comprising:
receiving version information from the display terminal, wherein the version information has a mapping relationship with address information of the server;
determining the address information of the server according to the mapping relationship; and
searching for the server according to the address information of the server.

13. The mobile terminal according to claim 11, wherein the processor is further configured to execute steps comprising:
receiving address information from the display terminal, wherein the address information comprises address information of the display terminal and address information of the server; and
searching for the server according to the address information of the server.

14. The mobile terminal according to claim 11, wherein extracting the data ID from the data comprises:
acquiring a touch item list; and
extracting the data ID from the data through the touch item list.

15. The mobile terminal according to claim 11, wherein the data further comprises data prompt information and data attribute information.

16. A display terminal for displaying data, comprising:
a processor; and
a memory for storing instructions executable by the processor;
wherein the processor is configured to execute steps comprising:
receiving a data ID from a mobile terminal, wherein the data ID is extracted by the mobile terminal from data obtained according to a search request;
acquiring data address information corresponding to the data ID from a server; and
acquiring data content from the server for display according to the data address information.

17. The display terminal according to claim 16, wherein the processor is further configured to execute steps comprising:
sending version information and/or address information to the mobile terminal,
wherein the address information includes local address information and address information of the server, and wherein the version information has a mapping relationship with the address information of the server.

18. The display terminal according to claim 16, wherein acquiring the data address information corresponding to the data ID from the server comprises:
sending the data ID to the server; and
receiving the data address information corresponding to the data ID from the server, wherein the data address information is obtained from searching the data ID by the server.

19. The display terminal according to claim 16, wherein acquiring the data content from the server for display according to the data address information comprises:
accessing the data address information; and
downloading the data content from the server for displaying locally.

20. The display terminal according to claim 16, wherein the data further comprises data prompt information and data attribute information.
